(19) United States
(12) Patent Application Publication
(10) Pub. No.: US 2023/0196179 A1
(43) Pub. Date: Jun. 22, 2023

(54) INFERRING GRAPHS FROM IMAGES AND TEXT

(71) Applicant: Microsoft Technology Licensing, LLC, Redmond, WA (US)

(72) Inventors: Robin ABRAHAM, Redmond, WA (US); J. Brandon SMOCK, Seattle, WA (US)

(21) Appl. No.: 17/556,518

(22) Filed: Dec. 20, 2021

(51) Int. Cl. G06N 20/00; G06N 5/04

(52) U.S. Cl. CPC G06N 20/00; G06N 5/04

(57) ABSTRACT

The present disclosure relates to systems and methods that receive an input and infer a predicted graph based on information in the input. The systems and methods provide a representation of the predicted graph with a set of nodes and a set of edges. Various processing or tasks may be performed on the information provided in the predicted graph.

### BACKGROUND

In general, graph generation systems are trained to generate a specific type of graph for a specific type of input. In addition, graph generation systems generally generate graphs one piece at a time. Thus, instead of producing all the nodes and edges at one time for the graphs, the graph generation systems build the graphs in sections.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes receiving an input. The method includes using a machine learning model to infer a predicted graph based on information in the input, wherein the predicted graph includes a set of nodes and a set of edges. The method includes providing a representation of the predicted graph with the set of nodes and the set of edges emitted in parallel.

Some implementations relate to a method. The method includes receiving training input. The method includes using a machine learning model to generate at least one predicted graph from the training input based on information in the training input. The method includes generating a loss based on comparing at least one predicted graph to a ground truth graph, wherein the loss identifies differences between at least one predicted graph and the ground truth graph. The method includes providing the loss to the machine learning model. The method includes modifying the machine learning model to improve predictions based on the loss computed for different training inputs.

Some implementations relate to a system. The system may include at least one processor; memory in electronic communication with at least one processor; and instructions stored in the memory, the instructions being executable by at least one processor to: receive an input; use a machine learning model to infer a predicted graph based on information in the input, wherein the predicted graph includes a set of nodes and a set of edges; and provide a representation of the predicted graph with the set of nodes and the set of edges emitted in parallel.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example machine learning system for inferring graphs in accordance with implementations of the present disclosure.

FIG. 2A illustrates an example of the partial output of a machine learning model for predicting the nodes and edges for a graph from the set of all possibilities in accordance with implementations of the present disclosure.

FIG. 2B illustrates an example of the partial output of a machine learning model for predicting the nodes and edges for a graph from the set of all possibilities in accordance with implementations of the present disclosure.

FIG. 3 illustrates an example environment for training a machine learning system in accordance with implementations of the present disclosure.

FIG. 4 illustrates an example environment for using predicted graphs in accordance with implementations of the present disclosure.

FIG. 5 illustrates an example of an image of a molecule graph that can be recognized in accordance with implementations of the present disclosure.

FIG. 6 illustrates an example of an image of a process graph that can be recognized in accordance with implementations of the present disclosure.

FIG. 7 illustrates an example of an image of a transportation graph that can be recognized in accordance with implementations of the present disclosure.

FIG. 8 illustrates an example of images whose scene graphs can be recognized in accordance with implementations of the present disclosure.

FIG. 9 illustrates an example of a predicted document graph in accordance with implementations of the present disclosure.

FIG. 10 illustrates an example method flow for inferring graphs in accordance with implementations of the present disclosure.

FIG. 11 illustrates an example method flow for training machine learning models in accordance with implementations of the present disclosure.

### DETAILED DESCRIPTION

This disclosure generally relates to inferring graphs. Graph generation is a particular kind of structured prediction task, where the goal is to recognize or produce a graph describing or corresponding to a given input. Graph generation systems are generally trained to generate a specific type of graph for a specific type of input. In addition, graph generation systems generally generate graphs one piece at a time. Thus, instead of producing all the nodes and edges at one time for the graphs, the graph generation systems build the graphs in sections.

A graph is defined as:

G=(V,E), (1)

where V is a set of nodes and E is a set of edges between the nodes. Depending on the problem or application, nodes in a graph can be of different types, and attributes, such as, shape, label, color, etc. may be used to represent the various types of nodes in visual representations. Similarly, edges in a graph may be undirected, directed, or weighted (expressed by a weight label, edge thickness, edge length, etc.). Attributes, such as, color, thickness, label, etc. may also be used to denote different types of edges within a graph.

Typical systems for graph generation output graphs in either multiple discrete stages or autoregressively, rather than wholly in a single step. This can entail first producing all of the nodes in one step and then all of the edges between them in another step or generating both nodes and edges one-at-a-time and letting the system decide when the graph is complete. Because graphs have no such inherent ordering to their parts, such systems introduce an additional layer of complexity into the generation process. Such systems also lack the ability to self-correct, as errors produced at earlier stages automatically propagate to later stages.

Providing feedback to these systems to learn to produce graphs is challenging. Due in part to these difficulties it is typical for different applied graph generation tasks to each have their own custom approaches designed to address them, rather than to use a common set of graph generation techniques.

The present disclosure provides systems and methods that infer graphs from images and/or text. The present disclosure provides systems and methods that infer graphs from inputs where the nodes and edges might not be labeled or even obvious. The inputs may include an image, a document, a video, a scene, a map, audio, speech, text, or any combination thereof. In some implementations, the graphs are explicit in the input. For example, the graph is a visual representation that already exists in documents or images. In some implementations, the graphs are derived based on information in the input. For example, the graphs are derived based on identified entities in the text, audio, video, and/or images and identified relationships among the entities.

The systems and method of the present disclosure train a machine learning model architecture with relevant data in the training input to infer various types of graphs (e.g., molecules, process flows, maps, scene graphs, document graphs, etc.) from information in the input. Different training approaches are possible based on the type of graph to be output. When the nodes of the graph have a spatial location associated with them or are uniquely identified in some other way, the architecture may be trained with a set-based loss using the Hungarian algorithm. When the nodes of the graphs do not have a spatial location or otherwise uniquely identifying attribute, a novel graph-based loss, which uses a heuristic approach to solving the graph matching problem, may be used to train the network.

The systems and methods of the present disclosure provides a unified approach for inferring graphs given documents, images, text, video, and/or speech in the input where the nodes and edges might not be labeled or obvious in the input. Rather than produce graphs autoregressively or sequentially in stages, the described systems and methods output all of the nodes and edges of a graph simultaneously in parallel in a single step. This parallel decoding of the graph has significant advantages over sequential decoding, including being faster at inference time and simplifying the learning procedure by eliminating the dependence on the many arbitrary orders in which the graph can be produced. The parallel decoding of the graph also enables the graph generation task to be abstracted completely as an end-to-end learning problem, which among other things eliminates the need for custom-engineered approaches for each application. As such, the systems and methods of the present disclosure are flexible enough to accommodate a broad variety of problem formulations as expressed through the training data.

The foundational model architecture and approach of the systems and methods of the present disclosure may be adapted for various use cases by providing the relevant data for the various use cases in the training input. After the machine learning model has been trained, custom experiences relevant to the use cases may be constructed on the predicted graphs that are inferred by the machine learning model from inputs. The information (e.g., node labels, edge weights) provided in the predicted graphs may be used by applications and/or users of the systems to perform downstream tasks on the predicted graphs. In addition, the information provided in the predicted graphs may be used to generate insights.

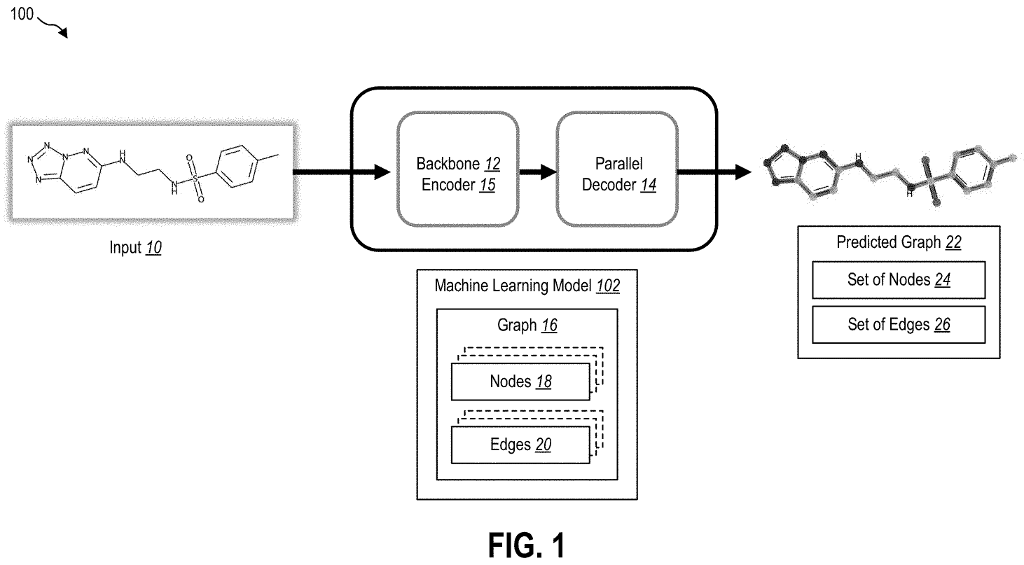

Referring now to FIG. 1, illustrated is an example machine learning system 100 for inferring or predicting graphs from inputs 10. The machine learning system 100 may include one machine learning model 102 consisting of multiple layers or components that compose together to generate an output graph. The machine learning model 102 may take multiple forms and involve completely different components depending on the task. For example, a machine learning system 100 may refer to any system architecture having multiple discrete machine learning components that consider different kinds of information or inputs.

In some implementations, the machine learning model 102 is a deep learning model that receives an input 10 and outputs a predicted graph 16 based on information in the input 10. In an example implementation for image input, the deep learning model takes the form of a standard transformer with distinct encoder and decoder modules that are preceded by a convolutional backbone module. The information in the input 10 includes, but is not limited to, diagrams, text, sketches, notes, maps, entities, objects, individuals, photographs, pictures, relationships among entities, objects, or individuals and/or actions among entities, objects, or individuals. The input 10 includes any images (photographs, pictures, diagrams, etc.), documents, videos, audio, speech, and/or text. In addition, the input 10 may include any combination of images, documents, videos, audio, speech, and/or text. Examples of the input 10 include, but are not limited to, documents, research papers, maps, webpages, charts, a visual scene, an audio scene, speech, pictures, photographs, and/or text.

The machine learning model 102 is trained to infer and/or predict various types of graphs given the input 10. Entities and/or relationships among the identified entities may also be inferred by the machine learning model 102 from many input modalities. Thus, regardless of the type (e.g., documents, images, audio, speech, and/or videos) of the input 10 received by the machine learning model 102, the machine learning model 102 outputs a predicted graph 22 based on the information in the input 10.

The machine learning model 102 includes a backbone 12, encoder 15, and a parallel decoder 14. In some implementations, the machine learning model 102 includes the encoder 15 and the parallel decoder 14. The architecture of the machine learning model 102 is flexible with respect to both the input and the intermediate layers. The encoder 15 processes its input and passes the processed input to the parallel decoder 14, which outputs the possible nodes 18 and/or possible edges 20 for one or more graphs 16 in the input 10 based on information in the input 10. In some implementations, the graphs 16 are explicit in the information in the input 10 (e.g., a visual representation that already exists in the input 10). For example, the input 10 includes a sketch of a molecule or a map of a city and the graph 16 is derived based on the sketch of the molecule or the map of the city. In this case, the machine learning model 102 is conceptually similar to an object detection model, where nodes are localized in the image like objects, and edges are additionally predicted between them. In some implementations, the graphs 16 are derived based on implicit information in the input 10. For example, the graphs 16 are derived based on entities without an explicit location in the text, audio, video, and/or images and identified relationships among the entities.

In some implementations, the encoder 15, and the parallel decoder 14 detect all possible combinations of the nodes 18 and the edges 20 for the graphs 16. In some implementations, the machine learning model 102 infers a single graph 16 from the input 10. In some implementations, the machine learning model 102 infers a plurality of graphs 16 from the input 10.

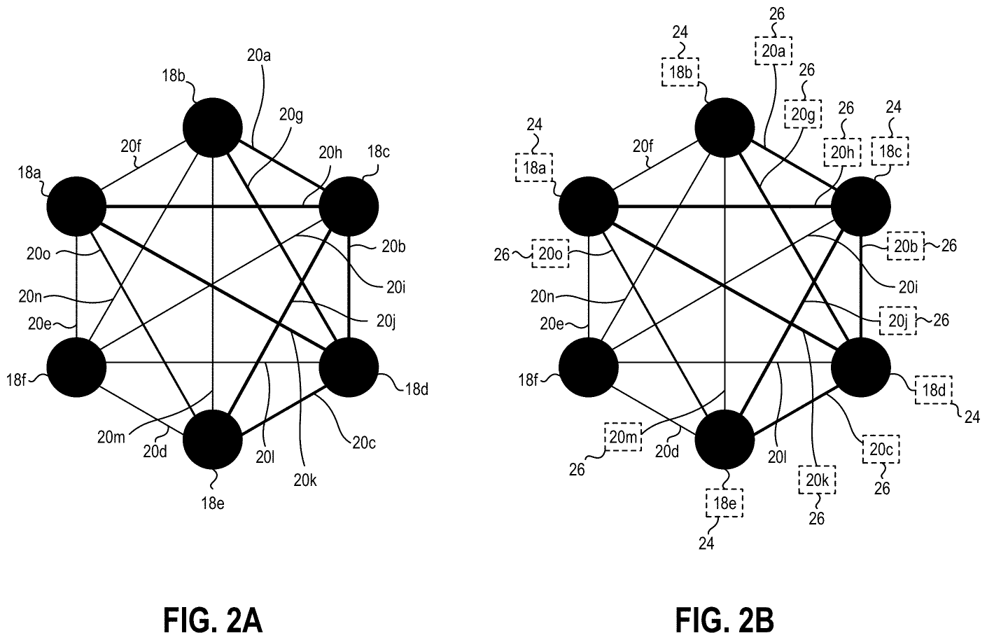

Referring now to FIG. 2A, illustrated is a representation of all of the possible outputs of an example architecture of the machine learning model 102 for predicting the possible nodes 18 and the possible edges 20 for a graph 16. The graph 16 includes six possible nodes 18 (e.g., node 18a, node 18b, node 18c, node 18d, node 18e, and node 18f) for the graph 16 inferred from the information in the input 10. In addition, the graph 16 includes fifteen possible edges 20 (e.g., edge 20a, edge 20b, edge 20c, edge 20d, edge 20e, edge 20f, edge 20g, edge 20h, edge 20i, edge 20j, edge 20k, edge 20l, edge 20m, edge 20n, edge 20o) between the different nodes 18. As such, the machine learning model 102 identifies which of the possible nodes 18 for the graph 16 and which of the possible edges 20 for the graph 16 to output.

Referring back to FIG. 1, the possible nodes 18 may be of different types and/or shape depending on a type of the graph 16, and/or a problem or application of the graph 16. Attributes (e.g., shapes, label, color, etc.) of the possible nodes 18 may be used to represent the different types of nodes in a visual representation of the graph 16. The different types of nodes include, for example, atoms in a molecule graph, process steps in a flow or process graph, cities in a map graph, stops on a transit route map graph, entities in a scene graph, and/or document portions in a document graph.

The possible edges 20 in the graph 16 may be undirected, directed, or weighted (expressed by a weight label, edge thickness, edge length, etc.). Attributes (e.g., color, thickness, label, etc.) of the possible edges 20 may also be used to denote different types of edges within the graph 16. Examples of the different types of edges 20 include bonds between atoms in a molecule graph, optional paths in a process flow graph, required steps in a process flow graph, roads that connect cities in a map graph, roads that connect bus stops in a transit route map graph, train tracks that connect train stops in a transit route map graph, relationships between entities in a scene graph, relationships between entities expressed in text of a document, and/or or actions performed between entities in an audio scene graph.

The machine learning model 102 classifies the different possible nodes 18 and/or edges 20 for the graph 16 and selects a set of nodes 24 from the possible nodes 18 and a set of edges 26 from the possible edges 20 for a predicted graph 22. The machine learning model 102 is trained to select the set of nodes 24 and/or the set of edges 26 selected for the predicted graph 22 based on the information received in the input 10. In one implementation, the machine learning model 102 uses a parallel decoder 14 that takes as part of its input N “node queries” (similar to object queries used by object detection models), representing a set of N possible output nodes from which the model chooses and outputs M actual nodes (where M is less than or equal to N). In this implementation, the machine learning model 102 also predicts a class label for each of the M output nodes indicating the node's type. Additionally, for each node, the machine learning model 102 predicts N edge labels, where the edge label at position Q for node P indicates whether nodes P and Q are connected and their edge type. Thus, in this implementation, the machine learning model 102 may predict a heterogeneous directed graph with up to N nodes and N*N directed edges in total.

Referring now to FIG. 2B, illustrated is an example architecture of the machine learning model 102 for selecting the set of nodes 24 and the set of edges 26 for the predicted graph 22. The set of nodes 24 and the set of edges 26 are selected from the possible nodes 18 (e.g., node 18a, node 18b, node 18c, node 18d, node 18e, and node 18f) and the possible edges 20 (e.g., edge 20a, edge 20b, edge 20c, edge 20d, edge 20e, edge 20f, edge 20g, edge 20h, edge 20i, edge 20j, edge 20k, edge 20l, edge 20m, edge 20n, edge 20o) for the graph 16 illustrated in FIG. 2B.

The set of nodes 24 and the set of edges 26 selected by the machine learning model 102 for the predicted graph 22 may be one possible combination of the nodes 18 and the edges 20 of the graph 16. In the illustrated example, the machine learning model 102 selects a subset of the possible nodes 18 (e.g., 18a, 18b, 18c, 18d, 18e) as the set of nodes 24 for the predicted graph 22. In addition, the machine learning model 102 selects a subset of the possible edges 20 (e.g., edge 20a, edge 20b, edge 20c, edge 20g, edge 20h, edge 20j, edge 20k, edge 20m, edge 20o) as the set of edges 26 for the predicted graph 16.

Referring back to FIG. 1, the machine learning model 102 outputs the predicted graph 22 with the selected set of nodes 24 and the set of edges 26. In some implementations, the machine learning model 102 uses a transformer decoder as the parallel decoder 14 with a collection of node queries fed into the parallel decoder 14. In addition to any other input passed into the network, the node queries are passed through the parallel decoder 14 and, unlike standard autoregressive approaches to graph generation, the final graph representation of the predicted graph 22 is emitted in parallel as the predicted set of nodes 24 and the set of edges 26. This has the advantage of not only being faster at inference time, but also means the machine learning model 102 learns to be permutation invariant (invariant to the ordering of the nodes). This eliminates the additional complexity encountered by autoregressive approaches, which must commit the model to producing the nodes and edges in a particular arbitrary order.

As such, the machine learning model 102 outputs a complete representation of the predicted graph 22 with the set of nodes 24 and the set of edges 26 at once together. The representation of the predicted graph 22 includes the labels for the set of nodes 24 or the set of edges 26 and/or any weights for the set of edges 26.

In some implementations, one or more computing devices (e.g., servers and/or devices) are used to perform the processing of the machine learning system 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the backbone 12, the encoder 15, and the parallel decoder 14 of the machine learning model 102 is implemented wholly on the same computing device. Another example includes one or more subcomponents (e.g., the backbone 12, the encoder 15, and/or the parallel decoder 14) of the machine learning model 102 are implemented across multiple computing devices. Moreover, in some implementations, one or more subcomponent (e.g., the backbone 12, the encoder 15, and/or the parallel decoder 14) may be implemented are processed on different server devices of the same or different cloud computing networks.

In the machine learning system 100, the same machine learning model 102 architecture is trained with the relevant data to infer various types of graphs (e.g., molecules, process flows, maps, scene graphs, document graphs, etc.) from information in the input 10. The machine learning system 100 provides a unified approach for inferring graphs given documents, images, text, video, and/or speech in the input 10 where the nodes 18 and edges 20 might not be labeled or obvious in the input 10. As such, the machine learning system 100 is flexible enough to accommodate a broad variety of problem formulations as expressed through the training data of the machine learning model 102.

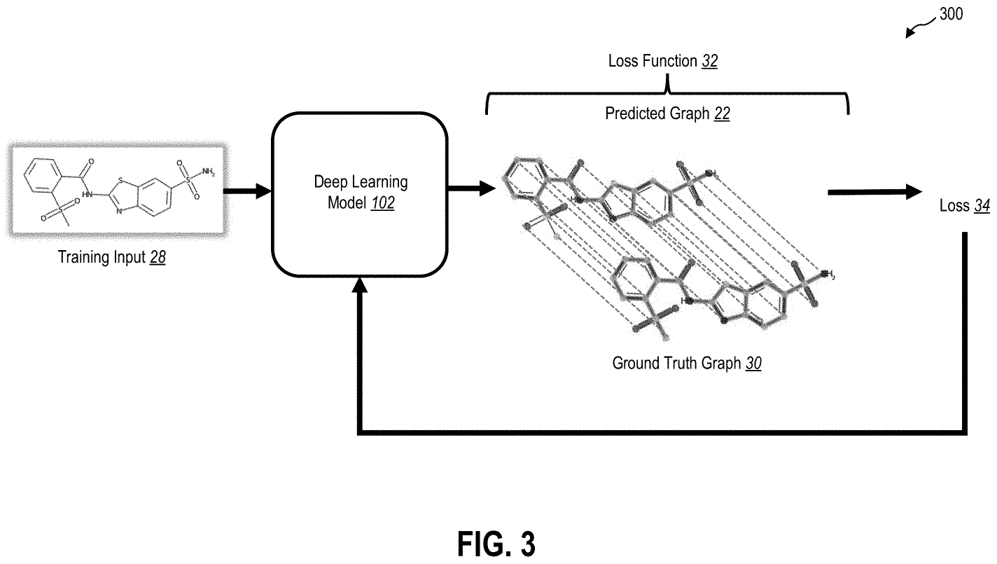

Referring now to FIG. 3, illustrated is an example environment 300 for training the machine learning system 100 (FIG. 1). The machine learning model 102 receives a plurality of training input 28. In some implementations, the training input 28 is an image. In some implementations, the training input 28 is text. In some implementations, the training input 28 is a document. In some implementations, the training input 28 is audio. The training input 28 may include any combination of images, text, documents, and/or audio.

The machine learning model 102 generates one or more predicted graphs 22 from the training input 28. In some implementations, the machine learning model 102 may be a deep learning model. In some implementations, the machine learning model 102 may include transformer networks, such as, but not limited to Bidirectional Encoder Representations from Transformers (BERT) models and/or Generative Pre-Trained Transformers (GPT). The transformer networks may be trained by processing the raw data of text from the training input 28. Other examples of the machine learning model 102 may include, but are not limited to, Embeddings from Language Models (ELMO), and/or any other machine learning model for natural language processing (NLP).

A loss function 32 is used to compare the one or more predicted graphs 22 to a ground truth graph 30 for the training input 28. The loss function 32 is used to generate a loss 34 for the predicted graph 22 based on the comparison of the predicted graph 22 to the ground truth graph 30. Different training approaches are possible based on the type of graph predicted by the machine learning model 102.

In one implementation, the loss function 32 is a graph alignment-based loss function. The graph alignment-based loss function first determines the optimal alignment between the nodes of the predicted graph and the ground truth graph 30, taking into account both the node types and edge types. In other words, the graph alignment-based loss function matches the nodes between the two graphs such that the matched nodes and their edges have the least amount of differences. The differences are quantified as a weighting of the numeric differences between the individual node types and edge types. Whatever numeric differences between the two graphs remain after matching become the loss that is backpropagated to the model.

The graph alignment problem is related to the graph isomorphism problem, which is known in general to be in the nondeterministic polynomial-time (NP) complexity class. Therefore, the graph-alignment-based loss function adopts a tractable heuristic algorithm to graph alignment (out of potentially many possible heuristic approaches that could be adopted). In the adopted approach, all possible pairwise permutations of the nodes of the predicted graph are considered and the algorithm iteratively makes any swap of two nodes that results in the predicted graph and ground truth graphs having fewer differences. The algorithm halts when no pairwise swap makes the two graphs more similar.

The graph alignment-based loss function is selected for comparing the predicted graph 22 to the ground truth graph 30 in response to the set of nodes 24 in the predicted graph 22 not having a spatial location or a unique identifying attribute. The graph-alignment-based loss function uses a heuristic approach for matching the predicted graph 22 to the ground truth graph 30.

In one implementation, the loss function 32 is a set-based loss function. The set-based loss function is selected for comparing the predicted graph 22 to the ground truth graph 30 in response to the set of nodes 24 in the predicted graph 22 having a spatial location or a unique identifying attribute. The existence of a uniquely identifying attribute for each node simplifies the algorithm required to match the nodes of the graph, as the nodes are all uniquely identifiable and no longer permutation invariant. 2D or 3D spatial location is one such uniquely identifying attribute, but others may exist. When nodes have a uniquely identifying attribute it is possible to use an optimal and more-efficient non-heuristic approach, such as, the Hungarian algorithm to match the graphs based only on their nodes. It is also possible to use a combination of the two algorithms. For example, initially matching the graphs using the Hungarian algorithm and then continuing to match the graphs using the graph alignment algorithm described earlier. Note that the numeric difference between the graphs is computed in the same way no matter which alignment algorithm is used, whether it be set-based, graph-based, or a hybrid of the two. In some implementations, the set-based loss function uses the Hungarian algorithm.

The loss 34 identifies any differences between the predicted graph 22 and the ground truth graph 30. One example includes the loss 34 identifying nodes that may be missing from the set of nodes 24 (FIG. 1) and/or edges that may be missing the set of edges 26 generated with the predicted graph 22 (e.g., nodes and/or edges that are present in the ground truth graph 30 but missing from the predicted graph 22). Another example includes the loss 34 identifying any extra nodes and/or edges included in the set of nodes 24 and/or the set of edges 26 generated with the predicted graph 22 (e.g., nodes and/or edges that are not included in the ground truth graph 30 but are included in the predicted graph 22). Another example includes the loss 34 identifying a node or edge placed in a different location as compared to a location of a corresponding node or edge in the ground truth graph 30. Another examples include the loss identifying nodes or edges that were correctly included but misclassified.

The loss 34 is provided to the machine learning model 102 as feedback on the predicted graph 22. The machine learning model 102 receives the loss 34 (e.g., the feedback on the predicted graph 22) and may use the feedback to improve a next predicted graph generated from the training input by modifying the weights or parameters of the learned model so that it makes fewer mistakes in the future.

As such, the environment 300 is used to train the deep learning model 102 to infer the predicted graphs 22 from a variety of training input 10 (e.g., text, images, documents, etc.) and/or improve the predicted graphs 22 using the variety of training input 10.

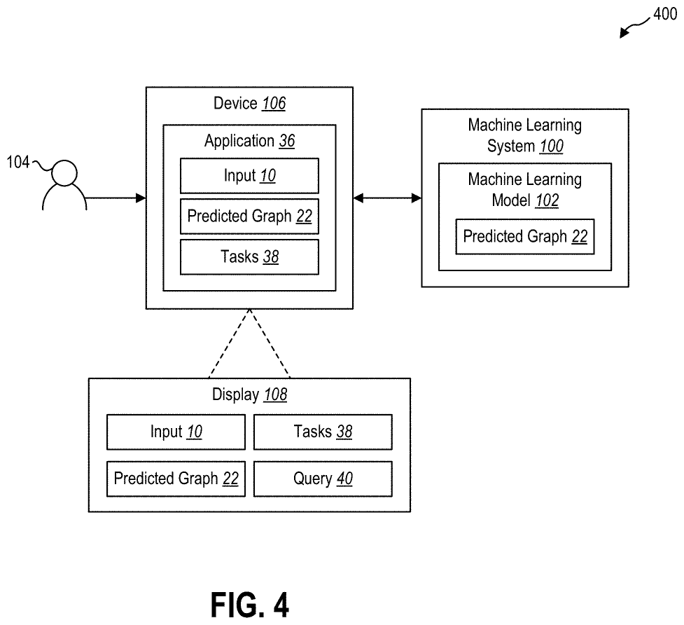

Referring now to FIG. 4, illustrated is an example environment 400 for performing various tasks 38 on the predicted graphs 22. The environment 400 may include one or more users 104 interacting with one or more devices 106. The devices 106 may include one or more applications 36 that allow the users 104 to interact with the predicted graphs 22 generated by the machine learning system 100. A representation of the predicted graph 22 is presented on a display 108. In some implementations, the device 106 receives the predicted graph 22 from the machine learning system 100 in response to a request from the application 36.

In some implementations, the device 106 receives the predicted graph 22 in response to the users 104 accessing an input 10 using the device 106. For example, the users 104 access a webpage on the device 106 with the input 10. Another example includes the user 104 accessing a datastore with research papers that include the input 10 using the device 106. Another example includes the user 104 accessing documents or text with the input 10 using the device 106. Another example includes the user 104 accessing videos with the input 10 using the device 106. The device 106 transmits the input 10 to the machine learning system 100 and receives the predicted graph 22 for the input 10 from the machine learning system 100.

In some implementations, the predicted graph 22 is provided in response to a query 40 provided by the user 104. The device 106 may provide the text of the query 40 to the machine learning system 100 as the input 10 and the machine learning system 100 provides the predicted graph 22 based on the text of the query 40. For example, the user 104 may enter in a query 40 for a molecule with specific properties and the machine learning system 100 provides a predicted graph 22 of a molecule that matches the specific properties from the query 40.

The predicted graph 22 may include knowledge and/or information in node labels, edge weights, etc., that may be used by the applications 36 to perform various tasks 38 on the information, such as, search and/or question-answering. The display 108 may present the predicted graph 22 to the user 104 and the user 104 may perform one or more tasks 38 on the information provided in the predicted graph 22. An example task 38 includes the user 104 providing a query (e.g., query 40) on the predicted graph 22 (e.g., what is the shortest path from A to B). The application 36 may use the information (e.g., node labels, edges, etc.) in the predicted graph 22 to answer the query provided by the user 104.

Another example task 38 includes the user 104 modifying the predicted graph 22 (e.g., changing nodes, removing nodes, adding nodes, changing a location of the nodes, changing labels of the graph, changing edges, removing edges, adding edges, changing a location of the edges, etc.). The representation of the predicted graph 22 is updated on the display 108 based on the modifications made to the predicted graph 22. For example, if the user 104 moved a location of a node and added an edge, the representation of the predicted graph 22 is presented on the display 108 with the new location of the node and the new edge. As such, the predicted graph 22 is interactive allowing edits and/or modifications to the predicted graph 22 by the user 104.

Another example task 38 includes the user 104 performing a search based on the predicted graph 22 (e.g., a search for finding other documents with the same molecule as shown in the predicted graph 22). The device 106 may access one or more datastores and perform a search of the documents in the datastore for other documents with the same molecule as included in the predicted graph 22.

One example use case includes the user 104 using the application 36 to view a PDF image of a table. The application 36 may transmit the PDF image as an input 10 to the machine learning system 100. The machine learning model 102 may generate a predicted graph 22 of the table included in the PDF image and provide the predicted graph 22 to the application 36. The user 104 may mark a portion of the table in the predicted graph 22 and extract the information from the marked portion. Thus, instead of having a static image in the PDF of the table, the user 104 is able to view an interactive predicted graph 22 of the table and perform different tasks 38 and/or processing on the information included in the predicated graph 22.

In some implementations, one or more computing devices (e.g., servers and/or the devices 106) are used to perform the processing of the machine learning system 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the applications 36 and the machine learning system 100 are implemented wholly on the same computing device. Another example includes one or more subcomponents of the applications 36 and/or the machine learning system 100 are implemented across multiple computing devices. Moreover, in some implementations, one or more subcomponent (e.g., the applications 36 and/or the machine learning system 100) may be implemented are processed on different server devices of the same or different cloud computing networks.

As such, the environment 400 may use the information (e.g., node labels, edge weights) provided in the predicted graphs 22 to perform downstream tasks 38 on the predicted graphs 22. The environment 400 may also use the information (e.g., node labels, edge weights) provided in the predicted graphs 22 to generate insights from the predicted graphs 22 and/or identify embedding similarities in the predicted graphs 22. The environment 400 may also be used to perform graph walks of the predicted graphs 22.

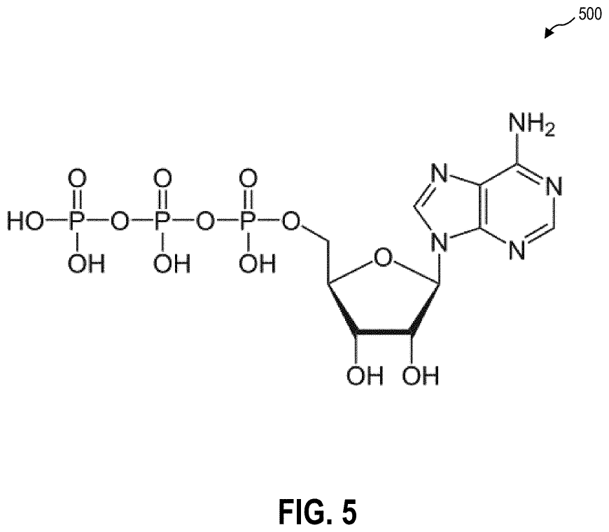

Referring now to FIG. 5, illustrated is an example of an image of a molecule graph 500 inferred by the machine learning system 100 (FIG. 1). In the molecule graph 500, the set of nodes 24 (FIG. 1) included in the molecule graph 500 are atoms and the set of edges 26 (FIG. 1) are the bonds between the atoms. Both, the types of the atoms (for example, oxygen, nitrogen, phosphorus, etc.), and the types of the bonds (single versus double bond, and chirality) are classified in the molecule graph 500 by the machine learning model 102 (FIG. 1). By classifying the set of nodes 24 and the set of edges 26, by the machine learning model 102, the molecule graph 500 may be used by different applications 36 (FIG. 3) for a variety of uses and/or tasks 38 (FIG. 3).

Once the molecule graph 500 is inferred by the machine learning model 102, the application 36 may translate the molecule graph 500 to alternate representations like SMILES, IUPAC, and InChI. The molecule graph 500 and/or the different representations may be leveraged to perform downstream tasks 38, such as, but not limited to, toxicity prediction, water solubility, and/or searching for similar molecules. The molecule graph 500 representation may also be used for searching for documents that contain pictures of specific molecules. For example, the applications 36 may use the molecule graph 500 for searching content datastores for research lab notes, articles, journal, and/or other types of text for documents that contain an image of the specific molecule represented by the molecule graph 500. As such, different applications 36 (FIG. 3) and/or users 104 (FIG. 3) may use the molecule graph 500 inferred by the machine learning system 100 to perform various tasks 38 (FIG. 3) or analyses on the molecule graph 500.

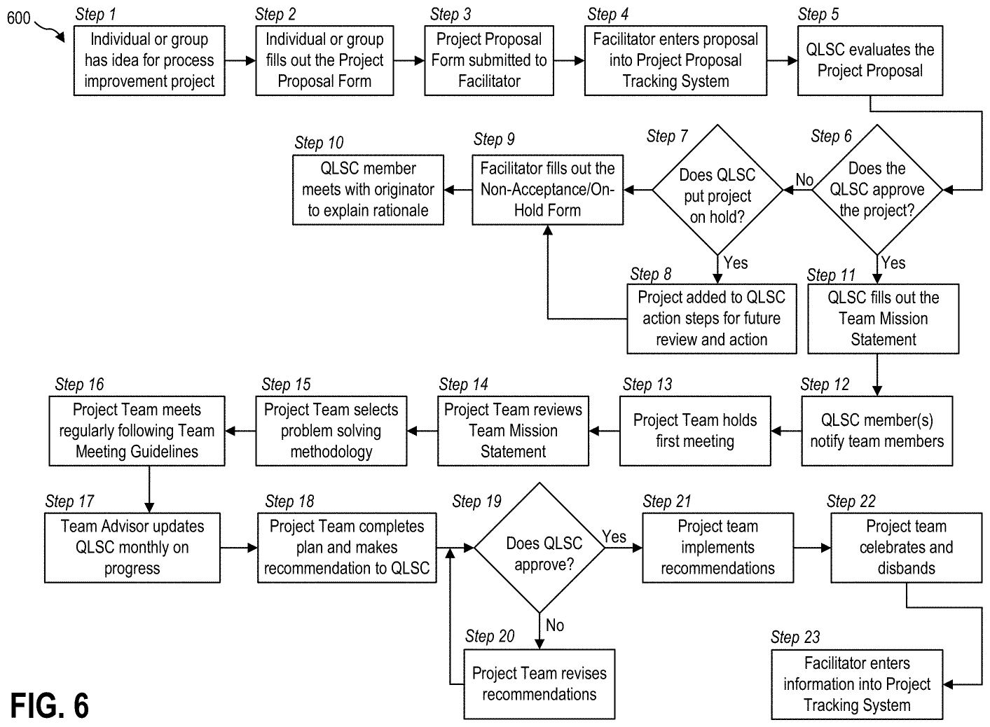

Referring now to FIG. 6, illustrated is an example of an image of a process graph 600 inferred by the machine learning system 100 (FIG. 1). In the process graph 600, the set of nodes 24 (FIG. 1) denote steps within a flow or process. The set of nodes 24 may be of multiple types and shapes, indicating start and terminating states, branching, and different types of intermediate steps. The set of edges 26 (FIG. 1) are directed and preserve the ordering of steps within the corresponding process. Dashed edges are used to show optional paths, as opposed to bold edges that indicate required next steps. As in the example use case with graphs inferred from molecules, both, nodes and edges, in the inferred graphs are labelled for many applications 36 (FIG. 3) to perform processing and/or analysis on the flow and process diagrams.

After the process graph 600 is inferred by the machine learning system 100, the process graph 600 may be used to answer queries 40 (FIG. 3). One example query includes a query for steps that may occur before and/or after a given step. The process graph 600 may also be used for different analyses, such as, “what are the most common steps in these processes?” or even “how does this process differ from these others?”. As such, different applications 36 and/or users 104 (FIG. 3) may use the process graph 600 inferred by the machine learning system 100 to perform various tasks 38 (FIG. 3) or analyses on the process graph 600.

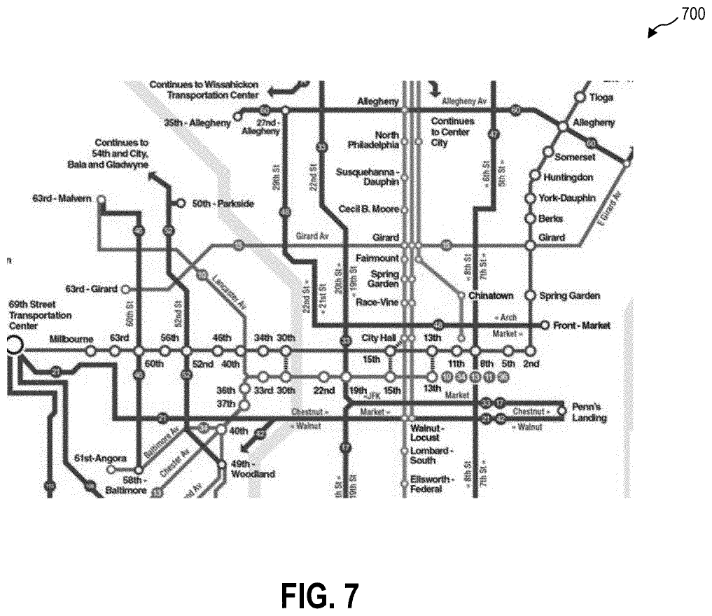

Referring now to FIG. 7, illustrated is an example of an image of a transportation map graph 700 inferred by the machine learning system 100 (FIG. 1). Depending on the type of map, nodes included in the set of nodes 24 (FIG. 1) may be bus stops, cities, etc. and edges included in the set of edges 26 (FIG. 1) may be roads that connect them. In general, the type of road will not matter, that is, edge detection is required for predicted map graphs 700 by the machine learning model 102, but not classification of the edges. The nodes are labelled in the predicted map graph 700. In predicted route map graphs 700, the length of the edges matter since the edges indicate distances between the nodes that the edges connect, and this information needs to be captured by the machine learning system 100 as edge weights in the predicted map graphs 700. If routes include one-way roads, the edges in the predicted map graphs 700 also need to be directed.

Applications 36 (FIG. 3) and/or users 104 (FIG. 3) may use the predicted map graph 700 to answer queries 40 (FIG. 3), such as, “what is the shortest path from A to B?”, “do I need to switch modes of transportation in getting from A to B?”, “if the route connecting A and C is blocked, how can I get to B from A?”, etc. Unlike the previous examples discussed in FIGS. 5, 6, and 7, in some implementations, the nodes or edges might not be explicit. For example, graphs may also be inferred from maps that show boundaries between regions (countries, states, counties, districts, lots, etc.). In this case, the regions become nodes within the predicted map graph 700 and edges connect regions that are adjacent to each other on the predicted map graph 700. In such implementations, typically, the nodes are labeled, but the edges do not have weights or direction since they only indicate adjacency.

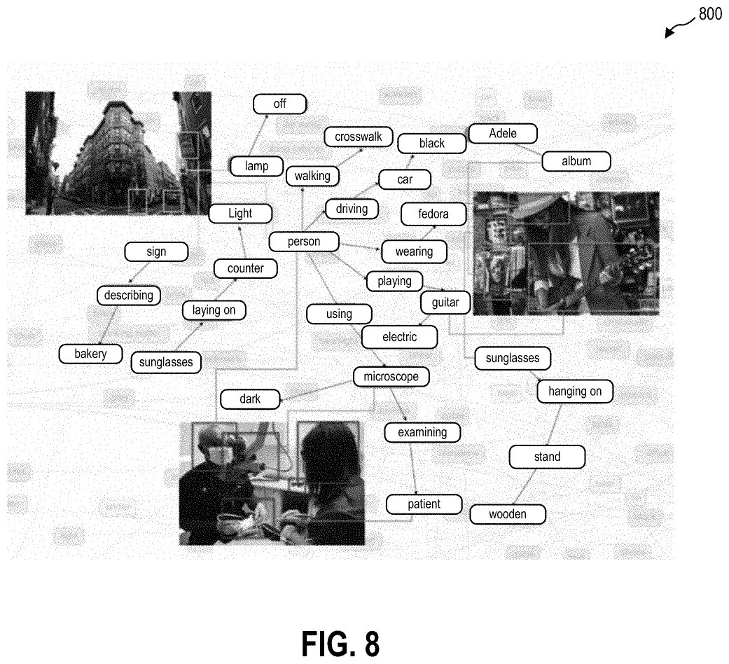

Referring now to FIG. 8, illustrated is an example of images whose scene graphs 800 may be inferred by the machine learning system 100 (FIG. 1). The predicted scene graph 800 may capture relationships between entities that are both spatial and conceptual. In a visual scene, entities or objects may be represented in the predicted scene graph 800 by nodes and the relationships between the entities or objects, including physical relationships in space and actions occurring between the entities or objects, may be represented as directed edges. For example, different color of nodes represent different types of nodes (e.g., green represents verbs and blue represents objects or individuals).

Such predicted scene graphs 800 may be small but have large numbers of node types and/or edge types and may have nodes with high degree that participate in many relationships within the same scene. A predicted scene graph 800 may encode knowledge, which may be used in downstream applications 36 (FIG. 1) to perform various tasks 38 or processing on the predicted scene graph 800, such as, search and question-answering. In some implementations, predicted scene graphs 800 from multiple scenes are combined to derive further knowledge not contained within any single scene on its own.

In some implementations, the predicted scene graph 800 is inferred by the machine learning system 100 from an audio scene. Entities and relationships among the entities may be inferred by the machine learning system 100 from the audio and/or speech. For example, entities may be in the context of an audio scene with actions performed between them. Additionally, knowledge can be expressed through natural language speech similar to text but with additional cues such as voice intonation or tone. As such, the machine learning model 102 may predict a scene graph 800 from the audio and/or speech from the audio scene.

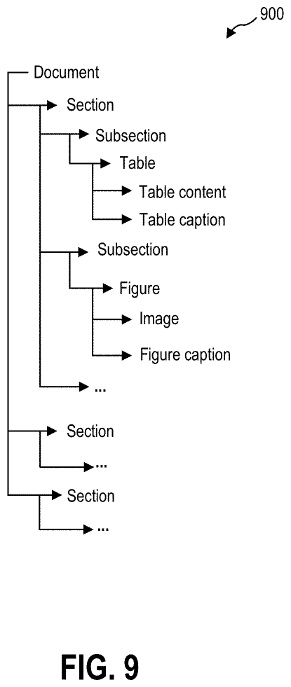

Referring now to FIG. 9, illustrated is an example of a predicted document graph 900 inferred by the machine learning system 100 (FIG. 1). The predicted document graph 900 may show the implicit tree structure of documents. Inferring the document structure from formats, such as, PDF may have many applications for document understanding and extraction pipelines. Entities and their relationships are often expressed in natural language, for example, within a sentence or paragraph of text. The machine learning system 100 may identify the entities and their relationships and extract a predicted document graph 900 based on the identified entities and relationships. Examples of predicted document graphs 900 extracted from text include parse trees and knowledge graphs.

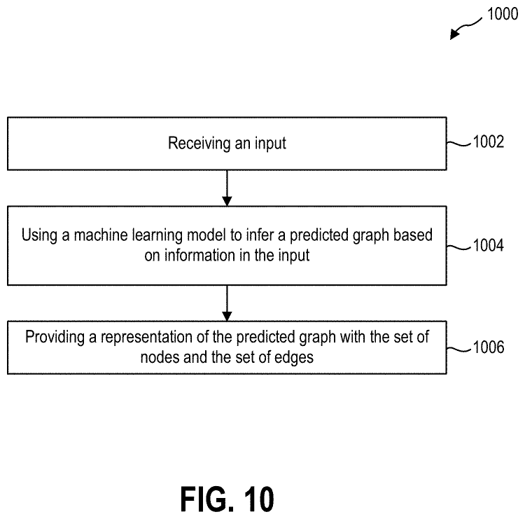

Referring now to FIG. 10, illustrated is an example method 1000 for inferring graphs. The actions of the method 1000 are discussed below with reference to the architectures of FIGS. 1-4.

At 1002, the method 1000 includes receiving an input. The machine learning model 102 receives the input 10. In some implementations, the input 10 includes one or more of an image, a document, a video, a scene, a map, audio, speech, or text. In some implementations, the input 10 includes any combination of documents, video, audio, speech, or text.

At 1004, the method 1000 includes using a machine learning model to infer a predicted graph based on information in the input. The machine learning model 102 infers a predicted graph 22 based on information in the input 10. The predicted graph 22 includes a set of nodes 24 and a set of edges 26.

In some implementations, the machine learning model 102 is trained to identify all possible nodes 18 and/or all possible edges 20 for the predicted graph 22. The machine learning model 102 selects the set of nodes 24 and the set of edges 26 from the possible nodes 18 and/or the possible edges 20 based on information in the input 10 and training of the machine learning model 102.

In some implementations, the machine learning model 102 identifies the set of nodes 24 and the set of edges 26 based on relationships expressed in natural langue of the text or the document of the input 10. In some implementations, the machine learning model 102 identifies the set of nodes 24 based on identified entities in the image or the video of the input 10 and the set of edges 26 based on identified relationships between the identified entities.

In some implementations, the machine learning model 102 identifies the set of nodes 24 based on identified entities in the audio or speech input 10 and the set of edges 26 based on actions performed between identified entities in the audio or the speech. In some implementations, the machine learning model 102 identifies the set of nodes 24 based on identified stops in the map in the input 10 and the set of edges based on a travel mode between the identified stops.

At 1006, the method 1000 includes providing a representation of the predicted graph with the set of nodes and the set of edges. In some implementations, the set of nodes 24 and the set of edges 26 are emitted in parallel. The representation of the predicted graph 22 may include different shapes and labels for the set of nodes 24 and one or more of undirected edges, directed edges, or weighted edges in the set of edges 26. For example, the representation of the predicted graph 22 may be presented on a display 108.

The method 1000 may optionally include receiving a query 40 and using the information in the set of nodes 24 and the set of edges 26 of the predicted graph 22 to provide an answer to the query 40.

The method 1000 may optionally include presenting the representation of the predicted graph 22 on a display 108 and receiving a modification of the set of nodes 24 or the set of edges 26 in the predicted graph 22. The representation of the predicted graph 22 may be updated based on the modifications of the set of nodes 24 or the set of edges 26.

As such, the method 1000 is used to infer various types of graphs (e.g., molecules, process flows, maps, scene graphs, document graphs, etc.) from information in the inputs 10.

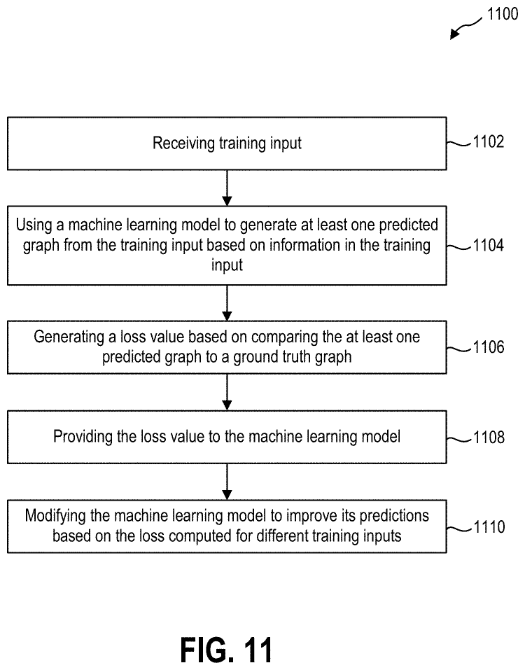

Referring now to FIG. 11, illustrated is an example method 1100 for training machine learning models. The actions of the method 1100 are discussed below with reference to the architectures of FIGS. 1-4.

At 1102, the method 1100 includes receiving training input. The machine learning model 102 receives the training input 28. In some implementations, the training input 28 is a document or text. In some implementations, the training input 28 is an image. In some implementations, the training input 28 is audio. In some implementations, the training input 28 is any combination of documents, text, images, and/or audio.

At 1104, the method 1100 includes using a machine learning model to generate at least one predicted graph from the training input based on information in the training input. The machine learning model 102 generates at least one predicted graph 22 from the training input 28 based on information in the training input 28.

In some implementations, the machine learning model 102 generates at least one predicted graph 22 from the document or text of the training input 28. In some implementations, the machine learning model 102 generates at least one predicted graph 22 from the image of the training input 28. In some implementations, the machine learning model 102 generates at least one predicted graph 22 from audio of the training input 28.

At 1106, the method 1100 includes generating a loss based on comparing at least one predicted graph to a ground truth graph. The loss 34 identifies differences between at least one predicted graph 22 and the ground truth graph 30 for the training input 28.

In some implementations, a graph alignment-based loss function is used for comparing at least one predicted graph 22 to the ground truth graph 30 in response to nodes of at least one predicted graph 22 not having a spatial location or a unique identifying attribute. The graph alignment-based loss function uses a heuristic approach matching at least one predicted graph 22 to the ground truth graph 30.

In some implementations, a set-based loss function is used for comparing at least one predicted graph 22 to the ground truth graph 30 in response to nodes of at least one predicted graph 22 having a spatial location or a unique identifying attribute. The set-based loss function may use the Hungarian algorithm.

At 1108, the method 1100 includes providing the loss to the machine learning model. The loss 34 is provided to the machine learning model 102 as feedback on the predicted graph 22.

At 1110, the method 1100 includes modifying the machine learning model to improve its predictions based on the loss computed for different training inputs. The machine learning model 102 receives the loss 34 (e.g., the feedback on the predicted graph 22) and may use the feedback to improve a next predicted graph generated from the training input by modifying the weights or parameters of the learned model so that the machine learning model 102 makes fewer mistakes in the future.

As such, the method 1100 is used to train the machine learning model 102 to infer predicted graphs 22 from a variety of training input 10 and/or improve the predicted graphs 22 generated by the machine learning model 102.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a transformer model, a classification model, a regression model, a language model, an object detection model) that can be tuned (e.g., trained) based on training input to approximate unknown functions. For example, a machine learning model may refer to a neural network (e.g., a transformer neural network, a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, embodiments of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. Unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving an input;
using a machine learning model to infer a predicted graph based on information in the input, wherein the predicted graph includes a set of nodes and a set of edges; and
providing a representation of the predicted graph with the set of nodes and the set of edges emitted in parallel.

2. The method of claim 1, wherein identifying the predicted graph further comprises:
identifying all possible nodes and edges for the predicted graph; and
selecting the set of nodes and the set of edges from the nodes and the edges based on information in the input and training of the machine learning model.

3. The method of claim 1, wherein the input includes one or more of an image, a document, a video, a scene, a map, audio, speech, or text.

4. The method of claim 3, wherein the machine learning model identifies the set of nodes and the set of edges based on relationships expressed in natural langue of the text or the document of the input.

5. The method of claim 3, wherein the machine learning model identifies the set of nodes based on identified entities in the image or the video of the input and the set of edges based on identified relationships between the identified entities.

6. The method of claim 3, wherein the machine learning model identifies the set of nodes based on identified entities in the audio or the speech of the input and the set of edges based on actions performed between identified entities in the audio or the speech.

7. The method of claim 3, wherein the machine learning model identifies the set of nodes based on identified stops in the map of the input and the set of edges based on a travel mode between the identified stops.

8. The method of claim 1, wherein the input includes any combination of documents, video, audio, speech, or text.

9. The method of claim 1, wherein the representation of the predicted graph includes different shapes and labels for the set of nodes and one or more of undirected edges, directed edges, or weighted edges in the set of edges.

10. The method of claim 1, further comprising:
receiving a query; and
using the information in the set of nodes and the set of edges of the predicted graph to provide an answer to the query.

11. The method of claim 1, further comprising:
presenting the representation of the predicted graph;
receiving a modification of the set of nodes or the set of edges in the predicted graph; and
updating the representation of the predicted graph based on the modifications of the set of nodes or the set of edges.

12. A method, comprising:
receiving training input;
using a machine learning model to generate at least one predicted graph from the training input based on information in the training input;
generating a loss based on comparing the at least one predicted graph to a ground truth graph, wherein the loss identifies differences between the at least one predicted graph and the ground truth graph;
providing the loss to the machine learning model; and
modifying the machine learning model to improve predictions based on the loss computed for different training inputs.

13. The method of claim 12, wherein the training input is a document or text, and the machine learning model generates the at least one predicted graph from the document or text.

14. The method of claim 12, wherein the training input is an image, and the machine learning model generates the at least one predicted graph from the image.

15. The method of claim 12, wherein the training input is audio, and the machine learning model generates the at least one predicted graph from the audio.

16. The method of claim 12, wherein generating the loss further comprises:
using a graph alignment-based loss function for comparing the at least one predicted graph to the ground truth graph in response to nodes of the at least one predicted graph not having a spatial location or a unique identifying attribute.

17. The method of claim 16, wherein the graph alignment-based loss function uses a heuristic approach matching the at least one predicted graph to the ground truth graph.

18. The method of claim 12, wherein generating the loss further comprises:
using a set-based loss function for comparing the at least one predicted graph to the ground truth graph in response to nodes of the at least one predicted graph having a spatial location or a unique identifying attribute.

19. A system, comprising:
at least one processor;
memory in electronic communication with the at least one processor; and
instructions stored in the memory, the instructions being executable by the at least one processor to:
receive an input;
use a machine learning model to infer a predicted graph based on information in the input, wherein the predicted graph includes a set of nodes and a set of edges; and
provide a representation of the predicted graph with the set of nodes and the set of edges emitted in parallel.

20. The system of claim 19, wherein the input includes one or more of an image, a document, a video, a scene, a map, audio, speech, or text.
